(19) United States
(12) Patent Application Publication
(10) Pub. No.: US 2006/0125984 A1
(43) Pub. Date: Jun. 15, 2006

(54) Display device and thin film transistor array panel for display device and manufacturing method thereof

(75) Inventors: Won-Sang Park, Gyeonggi-do (KR); Sang-Woo Kim, Gyeonggi-do (KR); Jae-Ik Lim, Gangwon-do (KR); Seung-Kyu Lee, Gyeonggi-do (KR); Sung-Eun Cha, Gyeongsangnam-do (KR); Poundaleva Irina, Gyeonggi-do (KR); Young-Joo Chang, Gyeonggi-do (KR); Jae-Young Lee, Seoul (KR); Jae-Hyun Kim, Gyeonggi-do (KR); Hae-Young Yun, Gyeonggi-do (KR); Kee-Han Uh, Gyeonggi-do (KR)

Correspondence Address: PATENT LAW GROUP LLP, 2635 NORTH FIRST STREET, SUITE 223, SAN JOSE, CA, 95134, US

(73) Assignee: Samsung Electronics Co., LTD.

(21) Appl. No.: 11/298,898

(22) Filed: Dec. 9, 2005

(30) Foreign Application Priority Data
Dec. 13, 2004 (KR) 10-2004-0104934

(51) Int. Cl. G02F 1/1335

(52) U.S. Cl. 349/114

(57) ABSTRACT

The present invention provides a TFT array panel comprising having a transmission region and a reflection region and: a substrate; a transmission electrode formed on the substrate; a reflection electrode formed on the transmission electrode and disposed on the reflection region; a first retardation layer formed on the reflection electrode; and a second retardation layer formed on the first retardation layer and having a fast axis facing a different direction from a fast axis of the first retardation layer.

### BACKGROUND OF THE INVENTION

(a) Field of the Invention

The present description relates to a display device, a thin film transistor (TFT) array panel for a display device, and a manufacturing method thereof.

(b) Description of the Related Art

Liquid Crystal Displays (LCDs) are one of the most widely used flat panel displays. An LCD includes a liquid crystal (LC) layer interposed between two panels provided with field-generating electrodes. The LCD displays images by applying voltages to the field-generating electrodes to generate an electric field in the LC layer that determines orientations of LC molecules in the LC layer to adjust polarization of incident light.

LCDs are classified into a transmissive LCD and a reflective LCD according to a light source, while the transmissive LCD has a backlight as a light source. The reflective LCD uses external light as a light source.

A transflective LCD which uses both a backlight and external light as a light source is also under development. The transflective LCD has the merits of both the transmissive LCD and the reflective LCD. The merits of the reflective LCD are low power consumption and good visibility in a bright environment and the merits of the transmissive LCD include good visibility in a dark environment such as an indoor situation. Accordingly, the transflective LCD can be used regardless of brightness of the environment and is useful for a mobile display due to its low power consumption.

The transflective LCD includes two polarizing films that allow only a specifically polarized light component to pass and are disposed on both sides of a liquid crystal panel of the LCD. A λ/4 retardation film is necessarily interposed between the liquid crystal panel and one of the polarizing films. The λ/4 retardation film induces phase retardation to the polarized light as much as ¼ of the wave length of the polarized light. Accordingly, a linearly polarized light is changed into a circularly polarized light by the λ/4 retardation film and a circularly polarized light is changed into a linearly polarized light by the λ/4 retardation film. When all range of the visible light is considered, additional retardation film such as λ/2 retardation film is required to induce λ/4 phase retardation.

However, such retardation films are expensive. Accordingly, manufacturing cost of the transflective LCD is higher than that of the transmissive LCD.

### SUMMARY OF THE INVENTION

The present invention provides an LCD having a retardation layer formed inside of a liquid crystal panel thereby reduces manufacturing cost.

The present invention provides a TFT array panel having a retardation layer and a manufacturing method thereof.

The present invention provides a TFT array panel comprising having a transmission region and a reflection region and: a substrate; a transmission electrode formed on the substrate; a reflection electrode formed on the transmission electrode and disposed on the reflection region; a first retardation layer formed on the reflection electrode; and a second retardation layer formed on the first retardation layer and having a fast axis facing a different direction from a fast axis of the first retardation layer.

According to an embodiment of the present invention, the fast axis of the first retardation layer makes an angle between 50° and 70° with the fast axis of the second retardation layer.

According to an embodiment of the present invention, the first retardation layer is a λ/4 phase retardation layer and the second retardation layer is a λ/2 phase retardation layer.

According to an embodiment of the present invention, the TFT array panel further comprises a third retardation layer disposed on the transmission region; and a fourth retardation layer disposed on the third retardation layer.

According to an embodiment of the present invention, the TFT array panel further comprises a polarizing film formed on the bottom surface of the substrate where the fast axes of the third and fourth retardation layers are parallel or orthogonal to the transmission axis of the polarizing film.

According to an embodiment of the present invention, the third retardation layer is a λ/4 phase retardation layer and the fourth retardation layer is a λ/2 phase retardation layer.

According to an embodiment of the present invention, the first and third retardation layers are formed as single layer and the second and fourth retardation layers are formed as single layer.

According to an embodiment of the present invention, the first to fourth retardation layers are liquid crystal layers formed of liquid crystals.

According to an embodiment of the present invention, the height of the reflection electrode is different from that of the transmission electrode.

The present invention provides a display device having a transmission region and a reflection region comprising: a first substrate having an inner surface and an outer surface; a second substrate having an inner surface and an outer surface, the inner surface of the first substrate facing the inner surface of the first substrate; a transmission electrode formed on the first substrate; a reflection electrode formed on the transmission electrode and disposed on the reflection region; a first retardation layer formed on the reflection electrode; and a second retardation layer formed on the first retardation layer and having a fast axis facing a different direction from a fast axis of the first retardation layer; a color filter formed on the second substrate; and a common electrode formed on the color filter.

According to an embodiment of the present invention, the fast axis of the first retardation layer makes an angle between 50° and 70° with the fast axis of the second retardation layer.

According to an embodiment of the present invention, the fast axes of the first and second retardation layers are formed as a pair selected from among 75° and 15°, −75° and −15°, 15° and 75°, and −15° and −75° with the transmission axis of the polarizing film.

According to an embodiment of the present invention, the first retardation layer is a λ/4 phase retardation layer and the second retardation layer is a λ/2 phase retardation layer.

According to an embodiment of the present invention, the display device further comprises a third retardation layer disposed on the transmission region; and a fourth retardation layer disposed on the third retardation layer.

According to an embodiment of the present invention, the display device further comprises a polarizing film disposed on the outer surface of the first substrate and where the fast axes of the third and fourth retardation layers are parallel or orthogonal to the transmission axis of the polarizing film.

According to an embodiment of the present invention, the third retardation layer is a λ/4 phase retardation layer and the fourth retardation layer is a λ/2 phase retardation layer.

According to an embodiment of the present invention, the thickness of the color filter disposed on the reflection region is different from the thickness of the color filter disposed on the transmission region.

According to an embodiment of the present invention, the display device further comprises a first insulating layer interposed between the second substrate and the color filter and disposed on the transmission region; and a second insulating layer formed on the common electrode and disposed on the reflection region, wherein the color filter has a hole on the reflection region.

The present invention provides a method of manufacturing a TFT array panel for a display device having a reflection region and a transmission region and comprising: forming a transmission electrode on a substrate; forming a reflection electrode on the transmission electrode to be disposed on the reflection region; forming a first retardation layer on the reflection electrode; and forming a second retardation layer to have a fast axis facing a different direction from a fast axis of the first retardation layer on the first retardation layer.

According to an embodiment of the present invention, the formation of the first retardation layer comprising: coating a first photo-aligning alignment layer on the reflection electrode; illuminating the first photo-aligning alignment layer through a first mask to generate an aligning direction; coating a liquid crystal material on the first photo-aligning alignment layer to form a first liquid crystal layer; and hardening the first liquid crystal layer.

According to an embodiment of the present invention, the formation of the second retardation layer comprising: coating a second photo-aligning alignment layer on the first retardation layer; illuminating the second photo-aligning alignment layer through a second mask to generate an aligning direction; coating a liquid crystal material on the second photo-aligning alignment layer to form a second liquid crystal layer; and hardening the second liquid crystal layer.

According to an embodiment of the present invention, the method further comprises forming a third retardation layer on the transmission electrode to be disposed on the transmission region; and forming a fourth retardation layer on the third retardation layer.

According to an embodiment of the present invention, the first and third retardation layers are formed by the same process and the second and fourth retardation layers are formed by the same process.

### BRIEF DESCRIPTION OF THE DRAWINGS

Preferred embodiments of the present invention can be understood in more detail from the following descriptions taken in conjunction with the accompanying drawings, in which:

FIG. 1 is a layout view of an LCD according to an embodiment of the present invention;

FIGS. 2 and 3 are sectional views of the LCD shown in FIG. 1 respectively taken along the lines II-II′ and III-III′;

FIG. 4 is a sectional view of an LCD according to another embodiment of the present invention;

FIGS. 5 to 8 are sectional views of LCDs according to other embodiments of the present invention;

FIGS. 9, 11, 13, and 15 are layout views sequentially illustrating the intermediate steps of a method of manufacturing a TFT array panel for an LCD according to the embodiment of FIGS. 1 and 4;

FIGS. 10, 12, 14, and 16 are sectional views of the TFT array panel respectively taken along the lines X-X′ of FIG. 9, XII-XII′ of FIG. 11, XIV-XIV′ of FIG. 13, and XVI-XVI′ of FIG. 15; and

FIG. 17 is a sectional view of a TFT array panel for an LCD according to the embodiment of FIGS. 1 and 4.

### DETAILED DESCRIPTION OF THE PREFERRED EMBODIMENTS

Preferred embodiments of the present invention will now be described more fully hereinafter with reference to the accompanying drawings, in which preferred embodiments of the invention are shown. The present invention may, however, be embodied in different forms and should not be construed as being limited to the embodiments set forth herein. Rather, these embodiments are provided so that this disclosure will be thorough and complete, and will fully convey the scope of the invention to those skilled in the art.

In the drawings, the thickness of layers, films, and regions are exaggerated for clarity. Like numerals refer to like elements throughout. It will be understood that when an element such as a layer, film, region, or substrate is referred to as being “on” another element, it can be directly on the other element or intervening elements may also be present.

Now, a display device according to an embodiment of this invention, a TFT array panel for the display device, and a manufacturing method thereof will be described in detail with reference to the accompanying drawings.

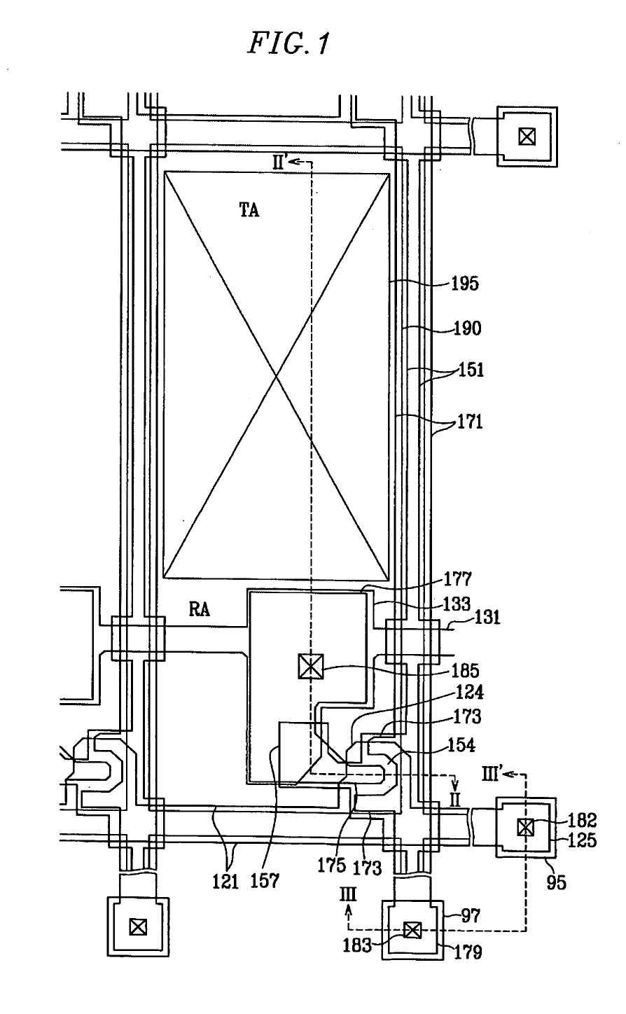

First, a display device according to an embodiment of this invention will be described with reference to FIGS. 1 to 3.

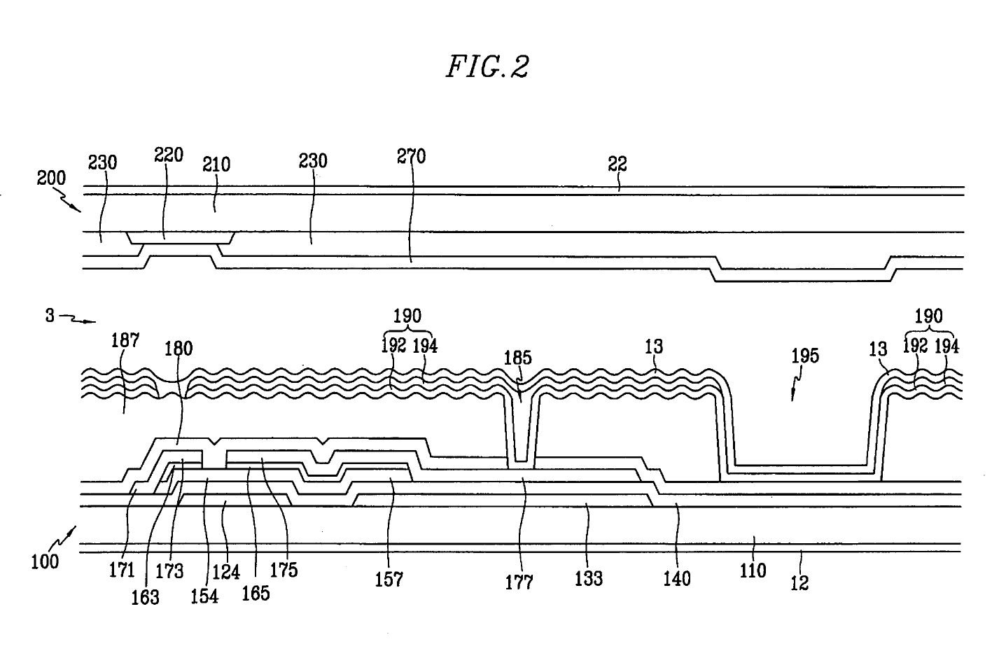

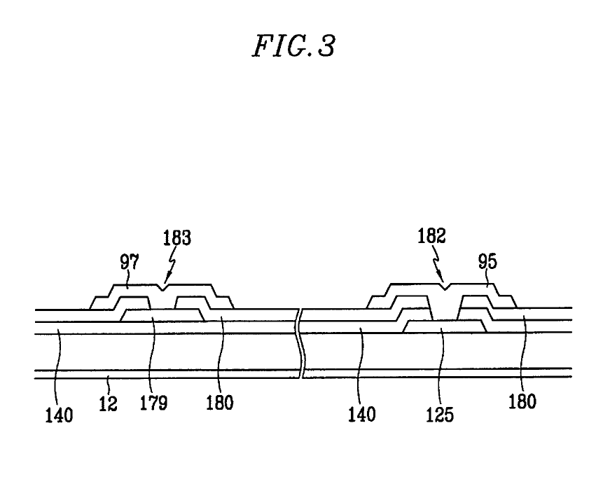

FIG. 1 is a layout view of an LCD according to an embodiment of the present invention. FIGS. 2 and 3 are sectional views of the LCD shown in FIG. 1 respectively taken along the lines II-II′ and III-III′.

The LCD according to the present embodiment has a TFT array panel 100, a common electrode panel 200 facing the TFT array panel 100, and a liquid crystal layer 3 interposed between the two panels 100 and 200 and having liquid crystals aligned in parallel or in vertical alignment to the two panels 100 and 200.

Liquid crystals in the liquid crystal layer 3 may be aligned to be twisted 90° between bottom side and top side of the liquid crystal layer 3 (the TN mode). Liquid crystals in the liquid crystal layer 3 may be aligned in vertical to the two panels 100 and 200 (the VA mode). Liquid crystals in the liquid crystal layer 3 may be aligned in parallel to the two panels 100 and 200 and to each other (the electrically controlled birefringence mode (ECB)).

Two polarizing films 12 and 22 are respectively disposed on outer sides of the two panels 100 and 200. Transmission axis of the upper polarizing film 22 is orthogonal to that of the lower polarizing film 12.

Henceforth, the TFT array panel 100 will be described in detail.

Referring to FIGS. 1 to 3, a plurality of gate lines 121 and storage electrode lines 131 are formed on an insulating substrate 110.

The gate lines 121 are mainly formed in the horizontal direction and transmit gate signals. Each gate line 121 has protrusions which become a plurality of gate electrodes 124. An end portion 125 of the gate line 121 has an expanded width for connecting with an external device such as a driving circuit.

The storage electrode lines 131 are mainly formed in the horizontal direction and having a plurality of protrusions forming storage electrodes 133. The storage electrode lines 131 are applied with a predetermined voltage such as common voltage that is applied to a common electrode 270 of the common electrode panel 200.

The gate lines 121 and the storage electrode line 131 are preferably made of one of an Al based metal such as pure Al and an Al alloy, an Ag based metal such as pure Ag and an Ag alloy, a Cu based metal such as Cu and a Cu alloy, a Mo based metal such as Mo and a Mo alloy, Cr, Ti, and Ta. The gate lines 121 and the storage electrode lines 131 may include two films having different physical characteristics, a lower film and an upper film. The upper film is preferably made of low resistivity metal including Al containing metal such as Al and Al alloy for reducing signal delay or voltage drop in the gate lines 121 and the storage electrode lines 131. On the other hand, the lower film is preferably made of material such as Cr, Mo, and Mo alloy such as MoW, which has good physical, chemical, and electrical contact characteristics with other materials such as indium tin oxide (ITO) and indium zinc oxide (IZO). Good example of combination of the lower film material and the upper film material is Cr and Al—Nd alloy. The gate lines 121 and the storage electrode lines 131 may have multi layers more than or equal to three.

In addition, the lateral sides of the gate lines 121 and the storage electrode lines 131 are inclined relative to a surface of the substrate 110, and the inclination angle thereof ranges about 30-80 degrees.

A gate insulating layer 140 made of such as SiNx is formed on the gate lines 121 and the storage electrode lines 131.

A plurality of semiconductor stripes 151 preferably made of hydrogenated amorphous silicon (abbreviated to “a-Si”) are formed on the gate insulating layer 140. Each semiconductor stripe 151 extends substantially in the longitudinal direction and has a plurality of projections 154 branched out toward the gate electrodes 124. A plurality of semiconductor segments 157 are extended from the projections 154 to cover portions of the storage electrodes 133.

A plurality of ohmic contact stripes 161 and islands 165 preferably made of silicide or n+ hydrogenated a-Si heavily doped with n type impurity are formed on the semiconductor stripes 151. Each ohmic contact stripe 161 has a plurality of projections 163, and the projections 163 and the ohmic contact islands 165 are located in pairs on the projections 154 of the semiconductor stripes 151.

The lateral sides of the semiconductors 151 and 157 and the ohmic contacts 161 and 165 are inclined relative to a surface of the substrate 110, and the inclination angles thereof are preferably in a range between about 30-80 degrees.

A plurality of data lines 171, a plurality of drain electrodes 175, and a plurality of storage capacitor conductors 177 are formed on the ohmic contacts 161 and 165 and the gate insulating layer 140.

The data lines 171 for transmitting data voltages extend substantially in the longitudinal direction and intersect the gate lines 121. Each data line 171 includes an expansion 179 having a larger area for contact with another layer or an external device.

A plurality of branches of each data line 171, which surround ends of the drain electrodes 175, form a plurality of source electrodes 173 . Each pair of the source electrodes 173 and the drain electrodes 175 are separated from each other and opposite each other with respect to a gate electrode 124. A gate electrode 124, a source electrode 173, and a drain electrode 175 along with a projection 154 of a semiconductor stripe 151 form a TFT having a channel formed in the projection 154 disposed between the source electrode 173 and the drain electrode 175.

The storage capacitor conductors 177 overlap portions of the storage electrodes 133 and the storage capacitor conductors 177 is formed on the semiconductor segments 157.

The data lines 171, the drain electrodes 175, and the storage capacitor conductors 177 are preferably made of a material having strong resistance against chemicals, such as Cr, Mo based metal, Ta, and Ti. The data lines 171, the drain electrodes 175, and the storage capacitor conductors 177 may have a multi layered structure including a lower film made of Mo, a Mo alloy, or Cr and an upper film located thereon and made of an Al containing metal or an Ag containing metal.

Like the gate lines 121 and the storage electrode lines 131, the data lines 171, the drain electrodes 175, and the storage capacitor conductors 177 have tapered lateral sides relative to the surface of the substrate 110, and the inclination angles thereof range about 30-80 degrees.

The ohmic contacts 161 and 165 are interposed only between the underlying semiconductors 151, 154, and 157 and the overlying data lines 171, drain electrodes 175, and storage capacitor conductors 177 and reduce the contact resistance therebetween. The semiconductor stripes 151 include a plurality of exposed portions, which are not covered with the data lines 171 and the drain electrodes 175, such as portions located between the source electrodes 173 and the drain electrodes 175.

A passivation layer 180 is formed on the data lines 171, the drain electrodes 175, the storage electrode capacitors 177, and exposed portions of the semiconductor stripes 151, which are not covered with the data lines 171 and the drain electrodes 175. The passivation layer 180 is preferably made of an inorganic insulating material such as SiNx or SiO₂. An organic insulating layer 187 is formed on the passivation layer 180. The organic insulating layer 187 is formed from a photosensitive organic material having good planarization characteristics. Here, organic insulating layer 187 has an embossed surface. The organic insulating layer 187 is removed on expansions 125 and 179 of the gate lines 121 and the data lines 171 thereby the passivation layer 180 is exposed.

The passivation layer 180 has contact holes 183 exposing the expansions 179 of the data lines 171. The passivation layer 180 and the gate insulting layer 140 have contact holes 182 exposing the expansions 125 of the gate lines 121. The passivation layer 180 and the organic insulating layer 187 have contact holes 185 exposing the drain electrodes 175. The contact holes 182, 183, and 185 may have a various horizontal section such as polygonal or circular shape and may have lateral surface inclined relative to a surface of the substrate 110, and the inclination angles thereof are preferably in a range between about 30-85 degrees.

A plurality of pixel electrodes 190 are formed on the organic insulating layer 187.

Each pixel electrode 190 includes a transmission electrode 192 and a reflection electrode 194 formed thereon. The transmission electrode 192 is made of a transparent conductive material such as ITO or IZO and the reflection electrode 194 is made of a metal having high reflectance, such as Al, an Al alloy, Ag, or an Al alloy. The reflection electrode 194 has an embossed surface due to the embossed surface of the organic insulating layer 187 thereby reflection characteristics of the reflection electrode 194 is enhanced.

The pixel electrode 190 may further include a contact assistant layer (not illustrated) made of Mo, a Mo alloy, Cr, Ti, or Ta. The contact assistant layer enhances contact characteristics between the transmission electrode 192 and the reflection electrode 194 thereby prevents the reflection electrode 194 from being corroded due to the transmission electrode 192.

A pixel has a transmission region TA and a reflection region (RA). The transmission region TA is a region where the reflection electrode 194 is not disposed and the reflection region RA is a region where the reflection electrode 194 is disposed. The organic insulating layer 187 has a transmission window 195 on the transmission region TA. Cell gap at the transmission region TA is almost as large as twice that at the reflection region RA. Accordingly, pass length of light experiencing the liquid crystal layer 3 of the reflection regions RA can be controlled to be almost the same as that of the transmission regions TA. As a result, difference of optical characteristics between the reflection mode and the transmission mode is reduced.

The pixel electrodes 190 are physically and electrically connected to the storage capacitor conductors 177 that is connected to the drain electrodes 175 through the contact holes 185 such that the pixel electrodes 190 receive the data voltages from the drain electrodes 175.

The pixel electrodes 190 supplied with the data voltages generate electric fields in cooperation with a common electrode 270. The electric fields reorient liquid crystal molecules in the liquid crystal layer 3 disposed therebetween.

The pixel electrode 190 and the common electrode 270 form a liquid crystal capacitor, which stores applied voltages after turn-off of the TFT. An additional capacitor called a “storage capacitor” is connected in parallel to the liquid crystal capacitor. The storage capacitors are implemented by overlapping of the storage capacitor conductors 177 of the drain electrodes 175 and the storage electrodes 133. The storage capacitors may be implemented by overlapping of the pixel electrodes 190 and previous gate lines 121. In this case, the storage electrode lines 131 may be omitted.

The pixel electrodes 190 overlap the gate lines 121 and the data lines 171 to increase aperture ratio but it is optional.

A plurality of contact assistants 95 and 97 are formed on the passivation layer 180.

The contact assistants 95 and 97 are connected to the exposed expansions 125 of the gate lines 121 and the exposed expansions 179 of the data lines 171 through the contact holes 182 and 183, respectively. The contact assistants 95 and 97 protect the expansions 125 and 179 and complement the adhesion between the expansions 125 and 179 and external devices. The contact assistants 95 and 97 are not essential components and may be formed of the same material as one of the transmission electrode 192 or the reflection electrode 194.

A retardation layer 13 is formed on the reflection electrodes 194 and exposed portions of the transmission electrodes 192. The retardation layer 13 compensates phase retardation of a light passing through it. The retardation layer 13 is formed by hardening a liquid crystal layer.

The retardation layer 13 induces a maximum of λ/4 phase retardation to a light passing through it.

The fast axis of the retardation layer 13 disposed on the reflection region RA makes an angle of 45° with the transmission axis of the upper polarizing film 22. Accordingly, the retardation layer 13 disposed on the reflection region RA induces the maximum phase retardation to a polarized light by the upper polarizing film 22. The retardation layer 13 generates a phase retardation as much as λ/4 between a component of the polarized light parallel to the fast axis and a component of the polarized light orthogonal to the fast axis. Thereby the retardation layer 13 disposed on the reflection region RA changes a linearly polarized light by the upper polarizing film 22 into a circularly polarized light and changes a circularly polarized light into a linearly polarized light.

Meanwhile, the fast axis of the retardation layer 13 disposed on the transmission region TA is parallel with the transmission axis of the lower polarizing film 12. Accordingly, the retardation layer 13 does not generate phase retardation for a light polarized by the lower polarizing film 12.

That is, the retardation layer 13 induces phase retardation for a reflected light that is polarized by the upper polarizing film 22 at the reflection region RA but does not induce phase retardation for a transmitting light that is polarized by the lower polarizing film 12 at the transmission region TA.

A photo-aligning alignment layer (not illustrated) is disposed between the pixel electrode 190 and the retardation layer 13. Illuminating directions may be differentiated between the reflection region RA and the transmission region TA to differentiate aligning directions between the two regions RA and TA. Thereby, fast axis of the retardation layer 13 can be controlled to face different directions between the two regions RA and TA.

The angle formed between the fast axes of the retardation layer 13 and the transmission axes of the two polarizing films 12 and 22 may be adjusted in a range from −5 to 5 degrees.

The common electrode panel 200 facing the TFT array panel 100 includes an insulating substrate 210 formed of transparent material such as a glass and a light blocking member 220 called as a black matrix. The light blocking member 220 prevents light leakage between the pixel electrodes 190 and defines aperture regions corresponding to the pixel electrodes 190.

A plurality of color filters 230 are formed on the substrate 210 and the light blocking member 220 to fill the aperture regions defined by the light blocking member 220. The color filters 230 disposed between adjacent two data lines 171 and aligned in a column may be connected to each other to form a stripe. The color filters 230 may filter one of the three primary colors such as red, green, and blue colors.

Each color filter 230 has two portions respectively corresponding to the transmission region TA and to the reflection region RA. The thickness of the color filter 230 in the transmission region TA is thicker that that on the reflection region RA to diminish difference of color tone between the two regions TA and RA, which is generated due to the difference between the two regions in the number of light transmissions passing through the color filter 230. As another way to compensate the difference of color tone, the color filter 230 may have pinholes disposed on the reflection region RA.

A common electrode 270 made of ITO or IZO is formed on the light blocking member 220 and the color filters 230.

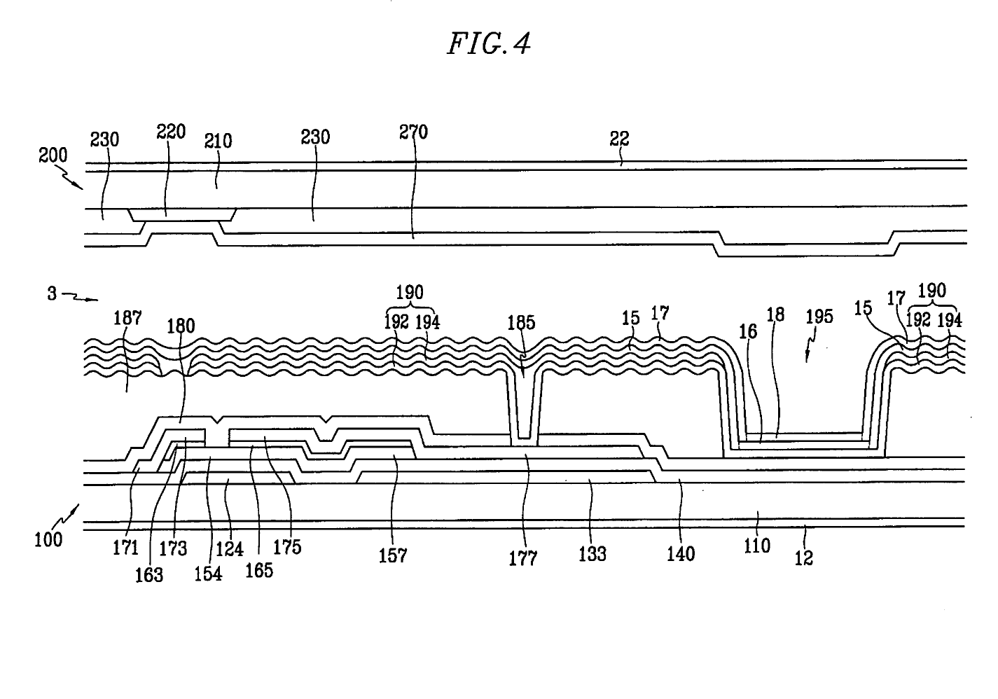

An LCD according to another embodiment of the present invention will be described in detail with reference to the FIG. 4.

FIG. 4 is a sectional view of an LCD according to another embodiment of the present invention.

Referring to FIG. 4, the LCD according to the present embodiment also has a TFT array panel 100, a common electrode panel 200 facing the TFT array panel 100, and a liquid crystal layer 3 interposed between the two panels 100 and 200.

An LCD according to the present embodiment has a similar layer structure to the LCD of FIGS. 1 to 3.

That is, the TFT array panel 100 has a plurality of gate lines 121 including gate electrodes 124 and a plurality of storage electrode lines 131 including storage electrodes 133, which are formed on a substrate 110. A gate insulting layer 140, a plurality of semiconductor stripes 151 including protrusions 154, and a plurality of ohmic contact stripes 161 having protrusions 163 and ohmic contact island 165 are sequentially formed on the gate lines 121 and the storage electrode lines 131. A plurality of data lines 171 having source electrodes 173 and a plurality of drain electrodes 175 are formed on the ohmic contacts 161 and 165. A passivation layer 180 and an organic insulating layer 187 are sequentially formed on the data lines 171 and the drain electrodes 175. The passivation layer 180 and the organic insulating layer 187 have a plurality of contact holes 182, 183, and 185. A plurality of pixel electrodes 190 including transmission electrodes 192 and reflection electrodes 194 are formed on the organic insulating layer 187. A lower polarizing film 12 is attached on outer side of the TFT array panel 100.

The common electrode panel 200 has a light blocking member 220, a plurality of color filters 230, and a common electrode 270 formed on an insulating substrate 210. An upper polarizing film 22 is attached on outer side of the common electrode panel 200. The transmission axis of the outer polarizing film 22 is orthogonal to that of the lower polarizing film 12.

As a distinguishing feature from the LCD of FIGS. 1 to 3, two retardation layers 15-18 are formed on the reflection electrodes 194 and exposed portions of the transmission electrodes 192. The retardation layers 15-18 compensate phase retardation of a light passing them through. The retardation layers 15-18 are formed by hardening two liquid crystal layers.

The lower retardation layer (15 and 16) induces a maximum of λ/4 phase retardation to a light passing through it. The upper retardation layer (17 and 18) induces a maximum of λ/2 phase retardation to a light passing through it.

Hereinafter, portions of the lower retardation layer (15 and 16), which are disposed on the reflection electrodes 194 will be called as a first retardation film 15 and portions of the lower retardation layer (15 and 16), which are disposed on the transmission electrodes 192 will be called as a second retardation film 16. Portions of the upper retardation layer (17 and 18), which are disposed on the reflection electrodes 194 will be called as a third retardation film 17 and portions of the upper retardation layer (17 and 18), which are disposed on the transmission electrodes 192 will be called as a fourth retardation film 18.

Henceforth, fast axis directions of the first to fourth retardation film will be describe with using the transmission axis of the upper polarizing film 22 as a base (0°).

The fast axis of the first retardation layer (15, 16) makes an angle between 50° and 70° with the fast axis of the second retardation layer (17, 18). Specifically, the angles of the fast axes of the first and third retardation films 15 and 17 are a pair of angles selected from among 75° and 15°, −75° and −15°, 15° and 75°, and −15° and −75°. The first and third retardation films 15 and 17 on the reflection region RA induce a λ/4 phase retardation to a polarized light through the upper polarizing film 22. Thereby the first and third retardation films 15 and 17 disposed on the reflection region RA change a linearly polarized light by the upper polarizing film 22 into a circularly polarized light and changes a circularly polarized light into a linearly polarized light.

The third retardation film 17 works as a compensation film and form a wide band λ/4 retardation film along with the first retardation film 15, thereby enhancing the black color, that is, diminishing light leakage to increase the depth of the black color.

Meanwhile, the fast axes of the second and fourth retardation films 16 and 18 on the transmission region TA are parallel or orthogonal to the transmission axis of the lower polarizing film 12. Accordingly, the second and fourth retardation films 16 and 18 do not generate phase retardation for a light polarized by the lower polarizing film 12. Therefore, the second and fourth retardation films 16 and 18 may be omitted.

Photoalignable alignment layers (not illustrated) are respectively disposed between the pixel electrode 190 and the lower retardation layer (15, 16) and between the lower retardation layer (15. 16) and the upper retardation layer (17, 18). Illuminating directions may be differentiated between the reflection region RA and the transmission region TA to differentiate aligning directions between the two regions RA and TA. Thereby, fast axes of the lower and upper retardation layer 15 to 18 can be controlled to face different directions between the two regions RA and TA.

The angle formed between the fast axes of the retardation layers 15-18 and the transmission axes of the two polarizing films 12 and 22 may be adjusted in a range from −5 to 5 degrees.

According to the present embodiment, a normal polarizing film, which is used in a transmissive LCD and is cheap, can be used instead of an expensive polarizing film for a transflective LCD thereby production price is reduced. Furthermore, since the first and third retardation layers 15 and 17 completely cover the reflection electrode 194, the reflection electrode 194 is prevented from being corroded and unevenness of the reflection electrode 194 is alleviated, thereby the deviation of cell gap in the reflection region RA is decreased. Accordingly, the highover defect that affects much of the production yield is remarkably reduced. A highover defect is a phenomenon that a pixel displays a brighter image than the image that should be displayed.

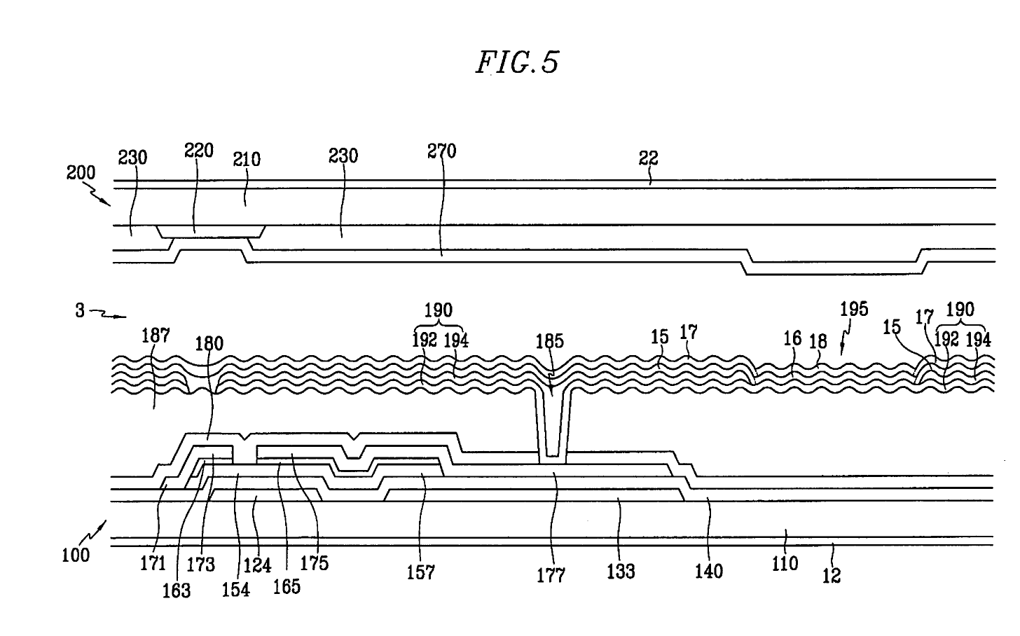

Other embodiments of the present invention will be described with reference to FIGS. 5 to 8.

FIGS. 5 to 8 are sectional views of LCDs according to other embodiments of the present invention;

Henceforth, only distinguishable features from the LCD of FIG. 4 will be described.

In the LCD illustrated in FIG. 5, the organic insulating layer 187 does not have transmission windows in the transmission regions TA. Accordingly, cell gap is uniform regardless of the transmission region TA or the reflection region RA.

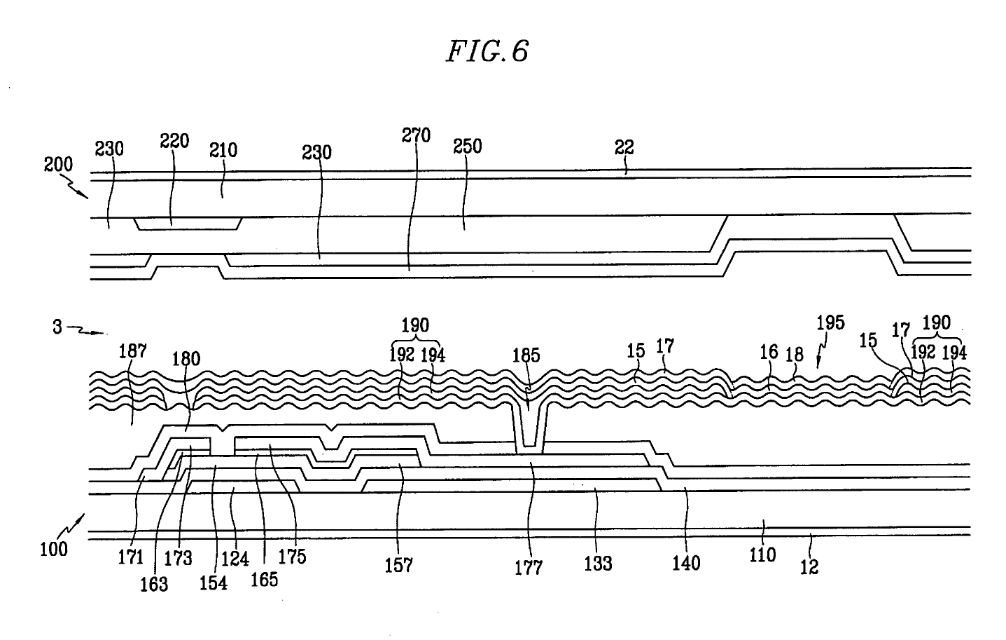

In the LCD illustrated in FIG. 6, the organic insulating layer 187 does not have transmission windows in the transmission regions TA like the LCD illustrated in FIG. 5. However, an overcoating layer 250 having openings corresponding to the transmission region TA is formed on the substrate 210 and the light blocking member 220 of the common electrode panel 200. The color filters 230 are formed on the overcoating layer 250 and the substrate 210. Thickness of the color filters 230 on the transmission region TA is greater than that on the reflection region RA. A common electrode 270 is formed on the color filters 230. Accordingly, cell gap in the transmission region TA may be formed as large as twice that in the reflection region RA by adjusting thickness of the overcoating layer 250.

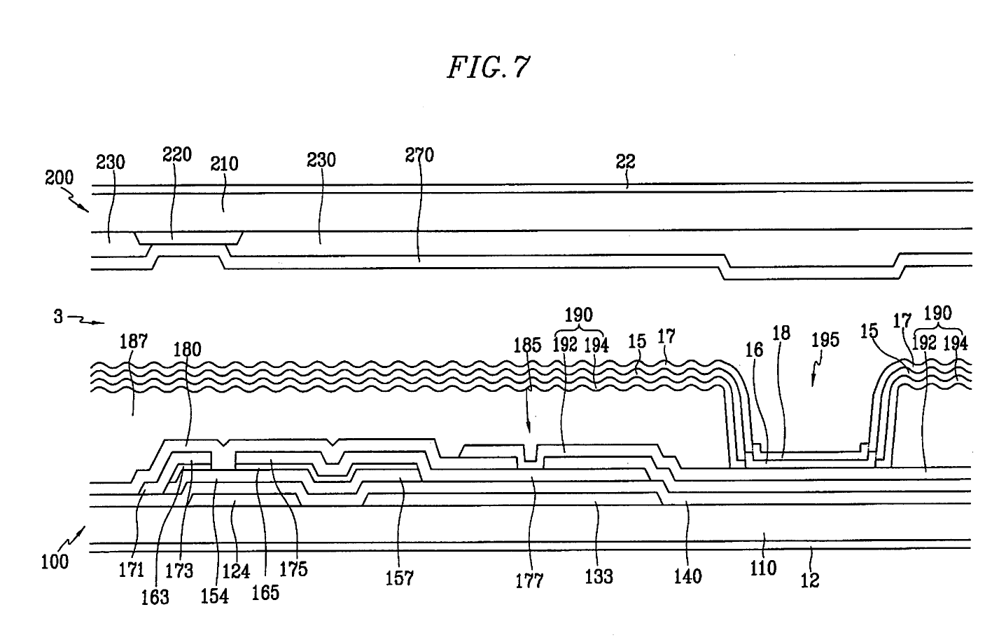

In the LCD illustrated in FIG. 7, the transmission electrodes 192 are formed between the passivation layer 180 and the organic insulating layer 187 and are connected to the storage capacitor conductors 177, which are connected to the drain electrodes 175, through contact holes 185 of the passivation layer 180. The organic insulating layer 187 is formed on the transmission electrodes 192 and has transmission windows 195 exposing the transmission electrode 192. The reflection electrodes 194 are formed on the organic insulating layer 187 and are connected to the transmission electrode 192 through the transmission windows 195.

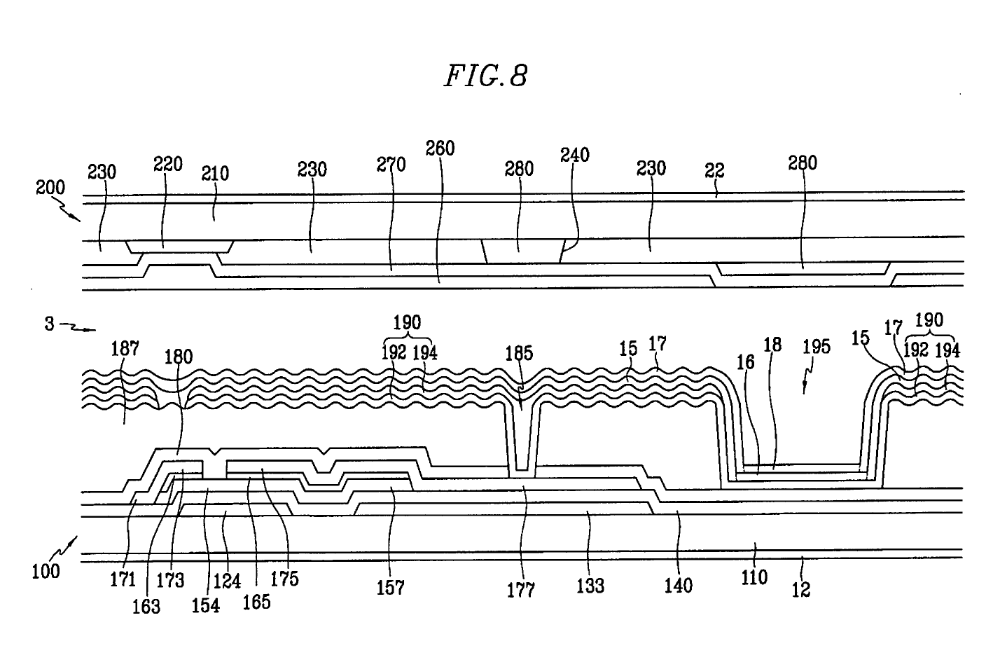

In the LCD illustrated in FIG. 8, the common electrode panel 200 has a light blocking member 220 and color filters 230 formed on a substrate 210. The color filters 230 have a substantially uniform thickness regardless of the transmission region TA or the reflection region RA. Each color filter 230 has a light hole 240 on the reflection region RA to diminish difference of color tone between the two regions TA and RA, which is generated due to number difference of transmitting the color filter 230.

A first insulating layer 280 is formed on the color filters 230 on the transmission region TA. The first insulating layer 280 is formed in the right hole on the reflection region RA to fill the right hole 240 thereby surface planarization of the color filters 230 is achieved.

A common electrode 270 is formed on the first insulating layer 280 and the color filters 230. The common electrode 270 has a uniform thickness. Accordingly, top surface of the common electrode 270 has height difference between the transmission region TA and the reflection region RA as much as the thickness of the first insulating layer 280.

A second insulating layer 260 is formed on the common electrode 270. The second insulating layer 260 is disposed on the reflection region RA. Height of top surface of the second insulating layer 260 is almost the same as that of the common electrode 270 on the transmission region TA. The second insulating layer 260 is preferably made of a material having a dielectric constant lower than the liquid crystal layer 3. For example, the second insulating layer 260 may be made of an organic insulating material such as an acrylic resin or a polyimide resin.

The distance between the common electrode 270 and the reflection electrode 194 in reflection region RA is different from the distance between the common electrode 270 and transmission electrode 192 due to the transmission window. Here, the distance differential is diminished due to the first insulating layer 280.

Furthermore, due to voltage distribution, voltage applied to the liquid crystal layer 3 disposed on the reflection region RA is smaller than the voltage applied to the liquid crystal layer 3 when the second insulating layer 260 is not formed. Here, the voltage applied to the liquid crystal layer 3 on the reflection region RA is reduced as the dielectric constant of the second insulating layer 260 is lowered.

Accordingly, differential of the voltage applied on the liquid crystal layer 3 between the reflection region RA and the transmission region TA, which is induced by the cell gap difference, is reduced thereby driving voltage may be decided to be the same between the reflection mode and the transmission mode.

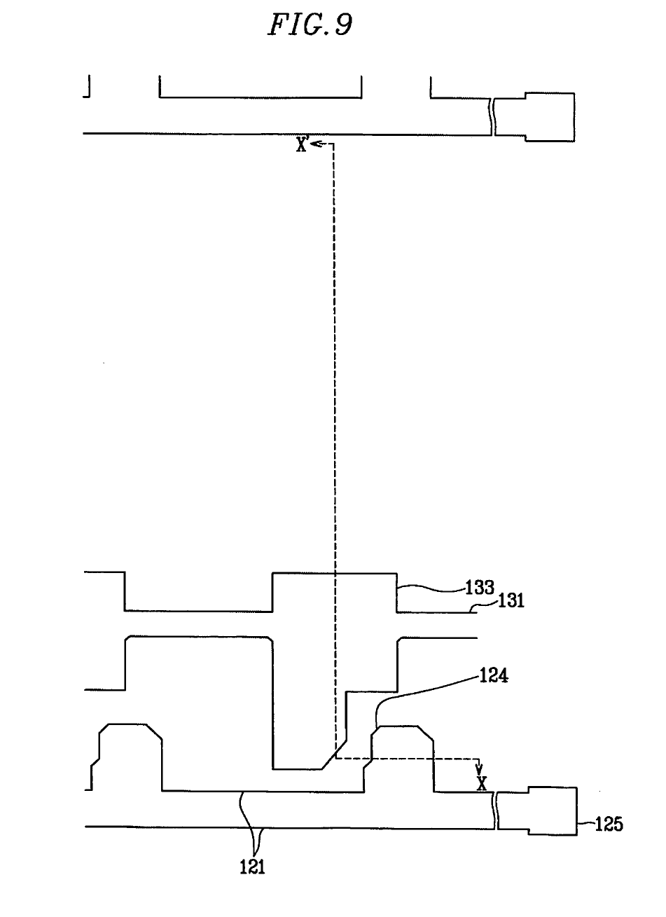

A manufacturing method of the TFT array panel shown in FIGS. 1 and 4 will be described with reference to the FIGS. 9 to 17.

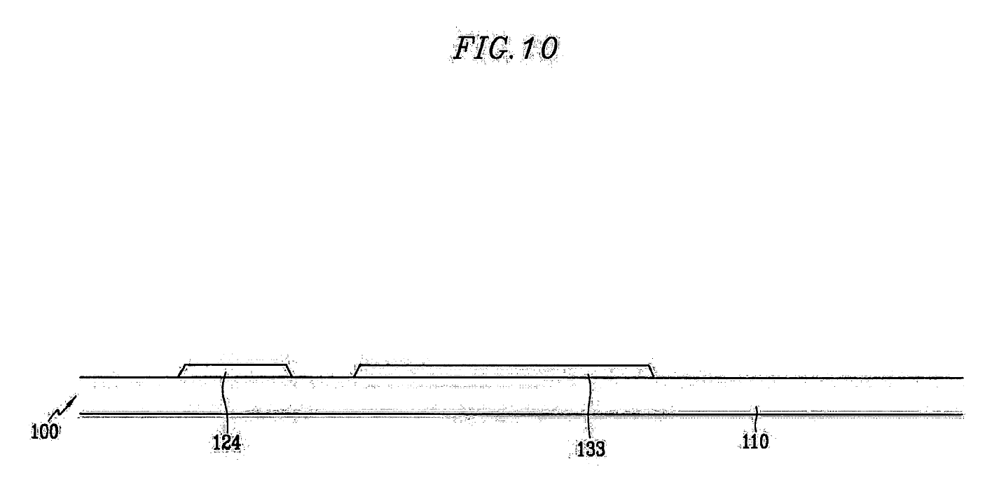

First, referring to FIGS. 9 and 10, a conductive layer made of one of an Al based metal such as pure Al and an Al alloy, an Ag based metal such as pure Ag and an Ag alloy, a Cu based metal such as Cu and a Cu alloy, a Mo based metal such as Mo and a Mo alloy, Cr, Ti, and Ta is deposited on an insulating substrate 110 by such as sputtering.

The conductive layer is patterned by photo-etching with a photoresist pattern to form a plurality of gate lines 121 including a plurality of gate electrodes 124 and expansions 125 and a plurality of storage electrode lines 131 including a plurality of storage electrode 133.

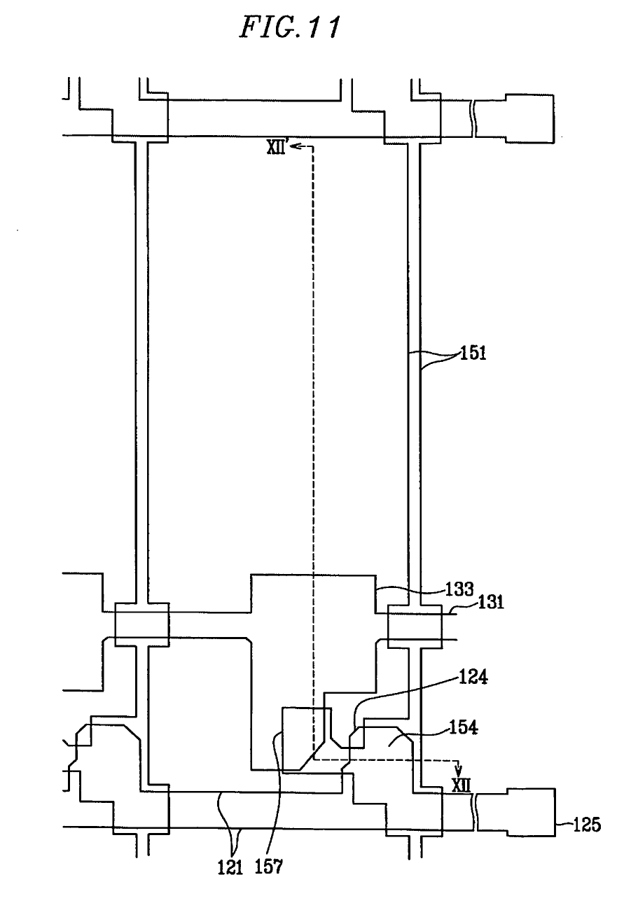

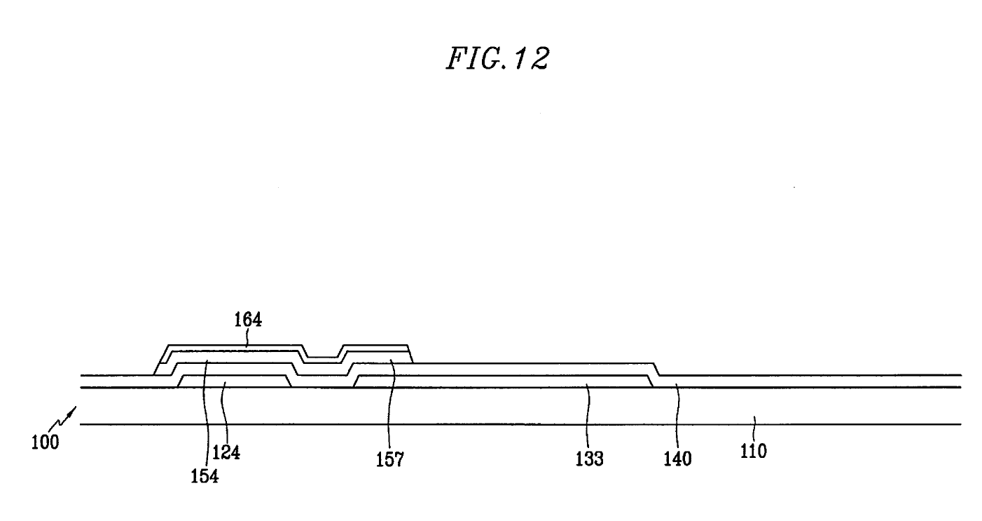

Referring to FIGS. 11 and 12, a gate insulating layer 140, an intrinsic a-Si layer, and an extrinsic a-Si layer are sequentially deposited by a method such as low temperature chemical vapor deposition (LPCVD) and plasma enhanced chemical vapor deposition (PECVD) to cover the gate lines 121 and storage electrode lines 131. Then, the intrinsic a-Si layer, and extrinsic a-Si layer are patterned to form a plurality of semiconductor stripes 151 including a plurality of protrusions 154 and expansions 157 and a plurality of ohmic contact pattern 164. The gate insulting layer 140 is made of a material such as SiNx.

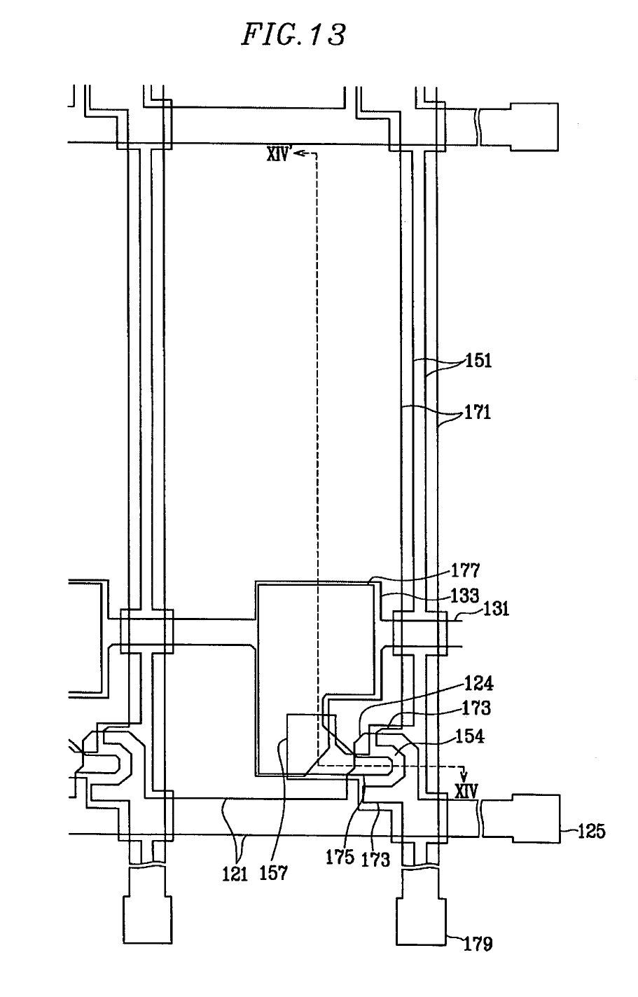

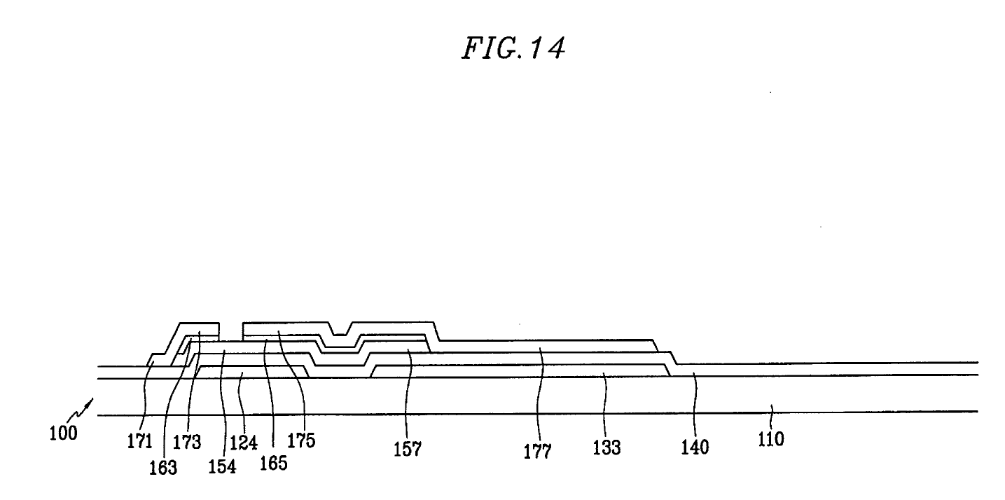

Referring to FIGS. 13 and 14, a conductive layer made of a metal having strong resistance against chemicals, such as a Cr based metal, a Mo based metal, Ta, and Ti is deposited by a method such as sputtering. Then, the conductive layer is patterned by a photo-etching to form a plurality of data lines 171 including source electrodes 173 and a plurality of drain electrodes 175 including storage capacitor conductors 177.

Next, portions of the extrinsic semiconductors 164, which are not covered with the data lines 171 and the drain electrodes 175 are removed by etch to complete a plurality of ohmic contacts 163 and 165 and to expose portions of the intrinsic semiconductors 150. Oxygen plasma treatment may follow thereafter in order to stabilize the exposed surfaces of the semiconductors 150.

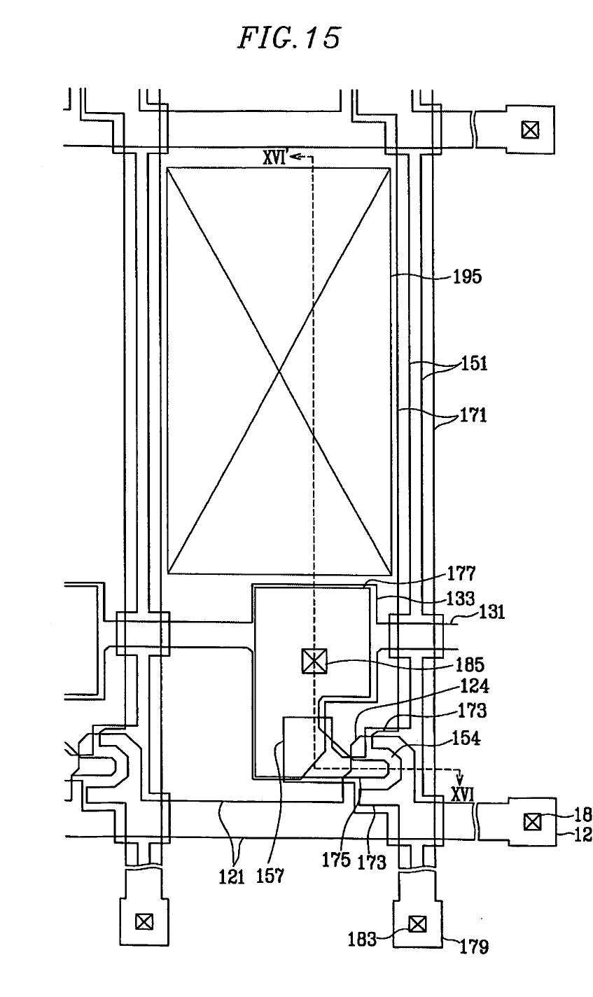

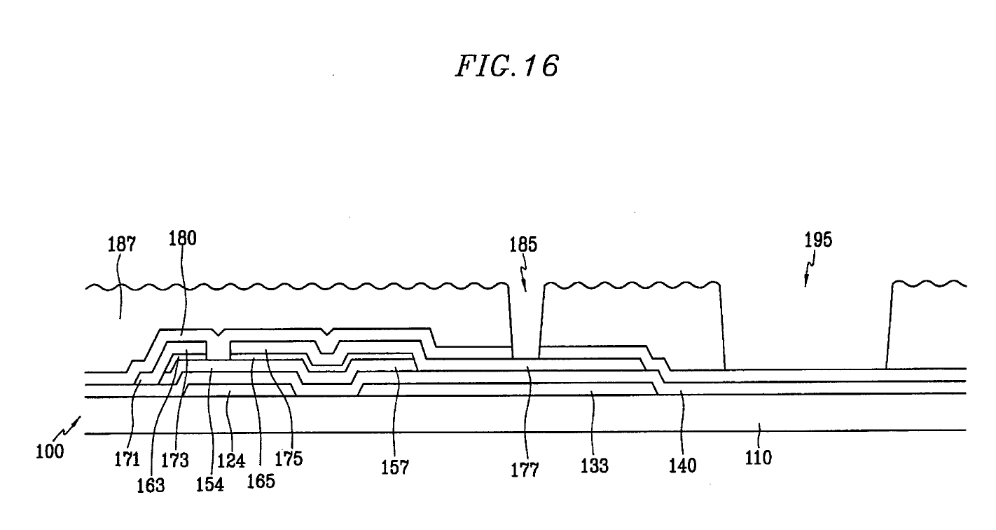

Referring to FIGS. 15 and 16, a passivation layer 180 is deposited by chemical vapor deposition (CVD) and an organic insulating layer 187 is coated on the passivation layer 180.

Next, the organic insulating layer 187 is patterned to form contact holes 185 exposing the passivation layer 180 over the storage capacitor conductors 177, transmission windows 195 exposing the passivation layer 180 on the transmission regions TA, and embossed surface of the organic insulating layer 187.

Then, the passivation layer 180 is patterned to complete the contact holes, thereby the contact holes expose the storage capacitor conductors 177.

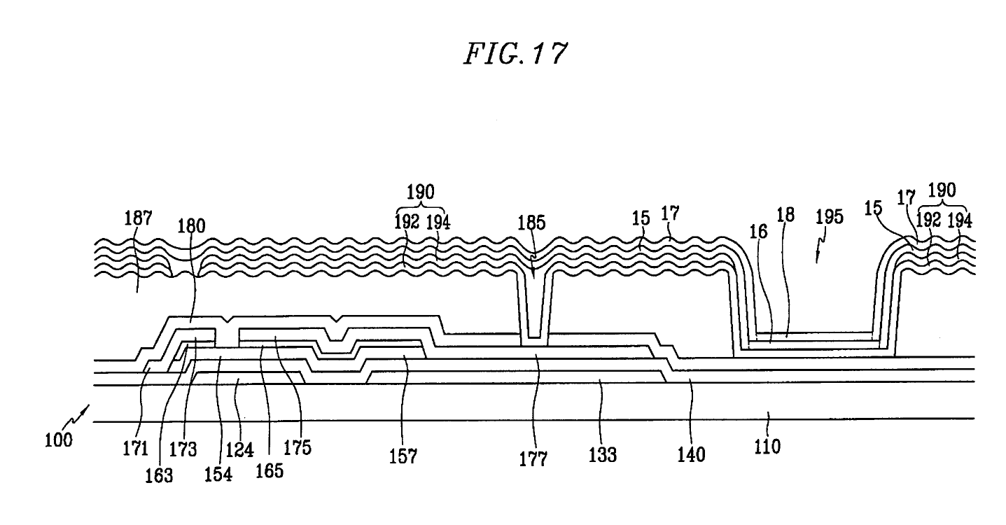

Referring to FIG. 17, a transparent conductive layer made of a material such as ITO or IZO is deposited and is patterned by photo-etching to form a plurality of transmission electrodes 192 connected to the drain electrodes 175 through the contact holes 185. Then, a reflection metal layer made of a material such as Ag or Al is deposited on the transmission electrodes 192 and is patterned by photo-etching to form a plurality of reflection electrodes 194 disposed on the reflection regions RA.

A photo-aligning alignment layer (not illustrated) is coated on the reflection electrodes 194 and the transmission electrodes 192. Then, the photo-aligning alignment layer is illuminated by a light through masks. Illumination directions are different between the reflection region RA and the transmission region TA thereby alignment directions are different between the reflection region RA and the transmission region TA. For example, portions disposed on the reflection electrode 194 are aligned in a direction making an angle of ±75° or ±15° with a transmission axis of a polarizing film that will be attached and portions disposed on the transmission electrode 192 are aligned in a direction making an angle of 0° or 90° with the transmission axis of the polarizing film. Next, a liquid crystal material is coated on the photo-aligning alignment layer and is hardened to form first and second retardation films 15 and 16.

Another photo-aligning layer is coated on the first and second retardation films 15 and 16. Then, the photo-aligning alignment layer is illuminated by a light through masks. Illumination directions are different between the reflection region RA and the transmission region TA thereby alignment directions are different between the reflection region RA and the transmission region TA. For example, portions disposed on the reflection electrode 194 are aligned in a direction making an angle of ±15° or ±75° with a transmission axis of a polarizing film that will be attached and portions disposed on the transmission electrode 192 are aligned in a direction making an angle of 0° or 90° with the transmission axis of the polarizing film. Next, a liquid crystal material is coated on the photo-aligning alignment layer and is hardened to form a third and fourth retardation films 17 and 18. The angles of the fast axes of the first and third retardation films 15 and 17 are a pair of angles selected from among 75° and 15°, −75° and −15°, 15° and 75°, and −15° and −75°.

Meanwhile, the second and fourth retardation layers 16 and 18 may be removed such as by etching.

According to the present embodiment, since the retardation layers are formed inside of an LCD, a normal polarizing film, which is used in a transmissive LCD and is cheap, can be used instead of an expensive polarizing film for a transflective LCD thereby production price is reduced.

Two retardation layers are applied to form a wide band λ/4 retardation film thereby enhancing the black color.

Furthermore, since the upper and lower retardation layers completely cover the reflection electrode, the reflection electrode is prevented from being corroded and unevenness of the reflection electrode is alleviated, thereby the deviation of cell gap in the reflection region RA is decreased. Accordingly, the highover defect that affects much of the production yield is remarkably reduced.

Although preferred embodiments of the present invention have been described in detail hereinabove, it should be clearly understood that many variations and/or modifications of the basic inventive concepts herein taught, which may appear to those skilled in the present art, will still fall within the spirit and scope of the present invention, as defined in the appended claims.

What is claimed is:

1. A TFT array panel having a transmission region and a reflection region and comprising:
a substrate;
a transmission electrode formed on the substrate;
a reflection electrode formed on the transmission electrode and disposed on the reflection region;
a first retardation layer formed on the reflection electrode; and
a second retardation layer formed on the first retardation layer and having a fast axis facing a different direction from a fast axis of the first retardation layer.

2. The TFT array panel of claim 1, wherein the fast axis of the first retardation layer makes an angle between 50° and 70° with the fast axis of the second retardation layer.

3. The TFT array panel of claim 2, wherein the first retardation layer is a λ/4 phase retardation layer and the second retardation layer is a λ/2 phase retardation layer.

4. The TFT array panel of claim 2, further comprising:
a third retardation layer disposed on the transmission region; and
a fourth retardation layer disposed on the third retardation layer.

5. The TFT array panel of claim 4, further comprising a polarizing film formed on the bottom surface of the substrate, wherein the fast axes of the third and fourth retardation layers are parallel or orthogonal to the transmission axis of the polarizing film.

6. The TFT array panel of claim 4, wherein the third retardation layer is a λ/4 phase retardation layer and the fourth retardation layer is a λ/2 phase retardation layer.

7. The TFT array panel of claim 4, wherein the first and third retardation layers are formed as single layer and the second and fourth retardation layers are formed as single layer.

8. The TFT array panel of claim 4, wherein the first to fourth retardation layers are liquid crystal layers formed of liquid crystals.

9. The TFT array panel of claim 2, wherein the height of the reflection electrode is different from that of the transmission electrode.

10. A display device having a transmission region and a reflection region and comprising:
a first substrate having an inner surface and an outer surface;
a second substrate having an inner surface and an outer surface, the inner surface of the first substrate facing the inner surface of the second substrate;
a transmission electrode formed on the first substrate;
a reflection electrode formed on the transmission electrode and disposed on the reflection region;
a first retardation layer formed on the reflection electrode; and
a second retardation layer formed on the first retardation layer and having a fast axis facing a different direction from a fast axis of the first retardation layer;
a color filter formed on the second substrate; and
a common electrode formed on the color filter.

11. The display device of claim 10, wherein the fast axis of the first retardation layer makes an angle between 50° and 70° with the fast axis of the second retardation layer.

12. The display device of claim 11, wherein the fast axes of the first and second retardation layers are formed as a pair of angles selected from among 75° and 15°, −75° and −15°, 15° and 75°, and −15° and −75°.

13. The display device of claim 11, wherein the first retardation layer is a λ/4 phase retardation layer and the second retardation layer is a λ/2 phase retardation layer.

14. The display device of claim 11, further comprising:
a third retardation layer disposed on the transmission region; and
a fourth retardation layer disposed on the third retardation layer.

15. The display device of claim 14, further comprising a polarizing film disposed on the outer surface of the first substrate and wherein the fast axes of the third and fourth retardation layers are parallel or orthogonal to the transmission axis of the polarizing film.

16. The display device of claim 14, wherein the third retardation layer is a λ/4 phase retardation layer and the fourth retardation layer is a λ/2 phase retardation layer.

17. The display device of claim 11, wherein the thickness of the color filter disposed on the reflection region is different from the thickness of the color filter disposed on the transmission region.

18. The display device of claim 11, further comprising:
a first insulating layer interposed between the second substrate and the color filter and disposed on the transmission region; and
a second insulating layer formed on the common electrode and disposed on the reflection region,
wherein the color filter has a hole on the reflection region.

19. A method of manufacturing a TFT array panel for a display device having a reflection region and a transmission region and comprising:
forming a transmission electrode on a substrate;
forming a reflection electrode on the transmission electrode to be disposed on the reflection region;
forming a first retardation layer on the reflection electrode; and forming a second retardation layer to have a fast axis facing a different direction from a fast axis of the first retardation layer on the first retardation layer.

20. The method of claim 19, wherein the formation of the first retardation layer comprising:
coating a first photo-aligning alignment layer on the reflection electrode;
illuminating the first photo-aligning alignment layer through a first mask to generate an aligning direction;
coating a liquid crystal material on the first photo-aligning alignment layer to form a first liquid crystal layer; and
hardening the first liquid crystal layer.

21. The method of claim 19, wherein the formation of the second retardation layer comprising:
coating a second photo-aligning alignment layer on the first retardation layer;
illuminating the second photo-aligning alignment layer through a second mask to generate an aligning direction;
coating a liquid crystal material on the second photo-aligning alignment layer to form a second liquid crystal layer; and
hardening the second liquid crystal layer.

22. The method of claim 19, further comprising:
forming a third retardation layer on the transmission electrode to be disposed on the transmission region; and
forming a fourth retardation layer on the third retardation layer.

23. The method of claim 22, wherein the first and third retardation layers are formed by the same process and the second and fourth retardation layers are formed by the same process.
